(19) United States
(12) Patent Application Publication
(10) Pub. No.: US 2006/0277064 A1
(43) Pub. Date: Dec. 7, 2006

(54) Method of creating a pricing schedule for use by a pharmaceutical pricing system

(76) Inventor: Michael Charles Cannata, Bloomingdale, IL (US)

Correspondence Address: MCCRACKEN & FRANK LLP, 200 W. ADAMS STREET, SUITE 2150, CHICAGO, IL, 60606, US

(21) Appl. No.: 11/146,464

(22) Filed: Jun. 7, 2005

(51) Int. Cl. G06Q 10/00

(52) U.S. Cl. 705/2

(57) ABSTRACT

A method of creating a pricing schedule for use by a pharmaceutical pricing system includes determining an average wholesale price (“AWP”) for the at least one predetermined quantity of a prescription drug and determining a median sales price for the at least one predetermined quantity of the prescription drug, wherein the median sales price is based on historical sales data. A gross profit percentage is calculated, wherein the gross profit percentage is based on the AWP and the median sales price. The gross profit percentage is then stored in the pricing schedule.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to a method of creating a pricing schedule for use by a pharmaceutical pricing system.

2. Description of the Background of the Invention

Providing prescription drugs to patients involves a complex system of drug distribution that includes a number of players, including manufacturers, wholesalers, and retailers. Each of these players participates in the pricing of generic and brand name drugs as either purchasers or providers and, therefore, the pricing of prescription drugs is highly complex.

The manufacturer sells the drug to a wholesaler and establishes a price that varies by the form and strength, and sometimes package size, of the product. When there is only a single manufacturer of a drug, as is often the case with a brand name drug, there is generally only one price for a specific product. Once generic versions of the drug become available, however, the equivalent medication may be offered at different prices by different manufacturers.

Wholesalers may sometimes receive discounts from manufacturers, based on volume or prompt payment. A manufacturer of a multi-source drug (i.e., one that is produced by more than one manufacturer, such as a generic drug) may also offer a discount to induce wholesalers to promote its particular version of the drug. Thus, for any particular drug, the price may more closely reflect the market position of the drug more than the cost of its production.

In the next transaction, the wholesaler sells the drug to a retail pharmacy at a price reflecting its cost of acquiring the drug plus a markup. The retail level of the distribution chain includes drug chains, independents, and mass merchandisers.

Finally, the pharmacy sells the drug to a consumer at a price that includes its cost for acquiring the drug from the wholesaler plus a retail markup. Part of this markup is a fixed cost that is not even related to the cost of acquiring a specific drug, and is oftentimes higher for independent pharmacies than for chain pharmacies or mass merchandisers. This is because the cost to the pharmacy of filling a prescription for a low-priced drug is likely to be the same as for a high-priced drug. As a result, the fixed cost is a higher percentage markup over acquisition cost for a low-price drug than for a high-price one. In addition, cash customers (i.e., those without insurance coverage and those with indemnity coverage) generally pay more for a given drug than those with third-party payments at the point of sale.

In one method of providing pharmaceutical services to a customer, a customer places an order for a pharmaceutical product with a covered entity, wherein the covered entity is one that is participating in a government program such as the Public Health Services Act (PHS). The covered entity then places the order with a contract pharmacy and transfers an account receivable of the customer to the contract pharmacy. The contract pharmacy places the order with a manufacturer and receives the order at a discount price, since the order is through a covered entity. The contract pharmacy sends the order back to the covered entity to administer the order and the contract pharmacy pursues compensation from the customer or the customer's insurance company. In another such method, cost savings are distributed to participants in a prescription drug distribution chain. When one participant selects a generic drug over a brand or other more expensive drug, the price difference is determined and distributed to all of the participants.

### SUMMARY OF THE INVENTION

According to one aspect of the invention, a method of creating a pricing schedule for use by a pharmaceutical pricing system includes determining an average wholesale price (“AWP”) for the at least one predetermined quantity of a prescription drug and determining a median sales price for the at least one predetermined quantity of the prescription drug, wherein the median sales price is based on historical sales data. A gross profit percentage is calculated, wherein the gross profit percentage is based on the AWP and the median sales price. The gross profit percentage is then stored in the pricing schedule.

According to a further aspect of the invention, a method of utilizing a pricing schedule to establish a suggested retail selling price of a prescription drug includes determining an average wholesale price (“AWP”) for at least one predetermined quantity of a prescription drug and determining a current pharmacy type. A pricing schedule is selected that includes a gross profit percentage for the at least one predetermined quantity of the prescription drug, wherein the at least one gross profit percentage is calculated for the predetermined pharmacy type. The suggested price is determined for the at least one predetermined quantity of the prescription drug based on the AWP and the gross profit percentage.

Other aspects and advantages of the present invention will become apparent upon consideration of the following detailed description, wherein like reference numbers in the various drawings designate like structures in the various embodiments.

### BRIEF DESCRIPTION OF THE DRAWINGS

FIG. 1 is a block flow diagram illustrating a method of creating a pricing schedule for use by a pharmaceutical pricing system according to one aspect of the present invention;

FIG. 2 is a table representing a pricing schedule according to the present invention; and

FIG. 3 is a block flow diagram illustrating a method of utilizing a pricing schedule to establish a suggested price of a prescription drug according to a further aspect of the present invention.

### DETAILED DESCRIPTION

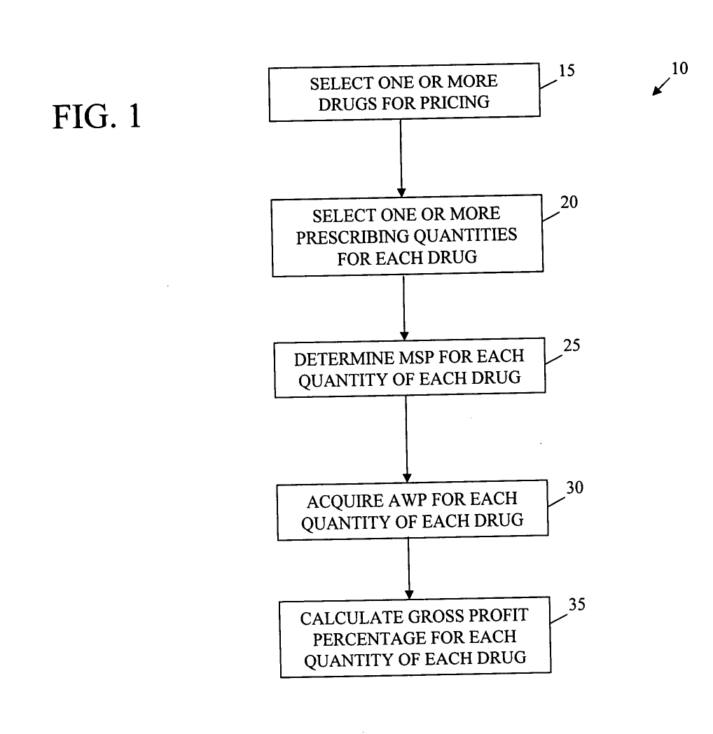

Turning now to the drawings, FIG. 1 shows a method of creating a pricing schedule for use by a pharmaceutical pricing system at 10. At block 15, one or more unique prescription drugs are selected for pricing; wherein the unique drugs may be brand name and/or generic drugs. Next, at block 20, one or more desired prescribing quantities for each of the identified drugs is selected.

At block 25, a median sales price (“MSP”) for each quantity of each of the selected drugs is determined and at block 30 an average wholesale price (“AWP”) for each quantity of each of the drugs is acquired. The AWP is a published wholesale price or list price suggested by the manufacturer of the drug. The AWP is often used by pharmacies as a cost basis for pricing drugs; however, it does not represent the actual cost to the pharmacy of acquiring the drug.

Finally, at block 35, a gross profit percentage (“GP %”) for each quantity of each of the drugs is calculated. The GP % represents the gross profit of each quantity of each of the drugs as compared to the AWP values and may be calculated using various equations. Preferably, the GP % is calculated using the following equation: ((1−(MSP/AWP))*−1)*100. Alternatively, the GP % is calculated by dividing a retail or acquisition price by the AWP.

All of this information is stored in the pricing schedule where it may be accessed and used by a pharmaceutical pricing system. The pricing schedule may be stored in a database, spreadsheet, text file, or any other appropriate storage mechanism.

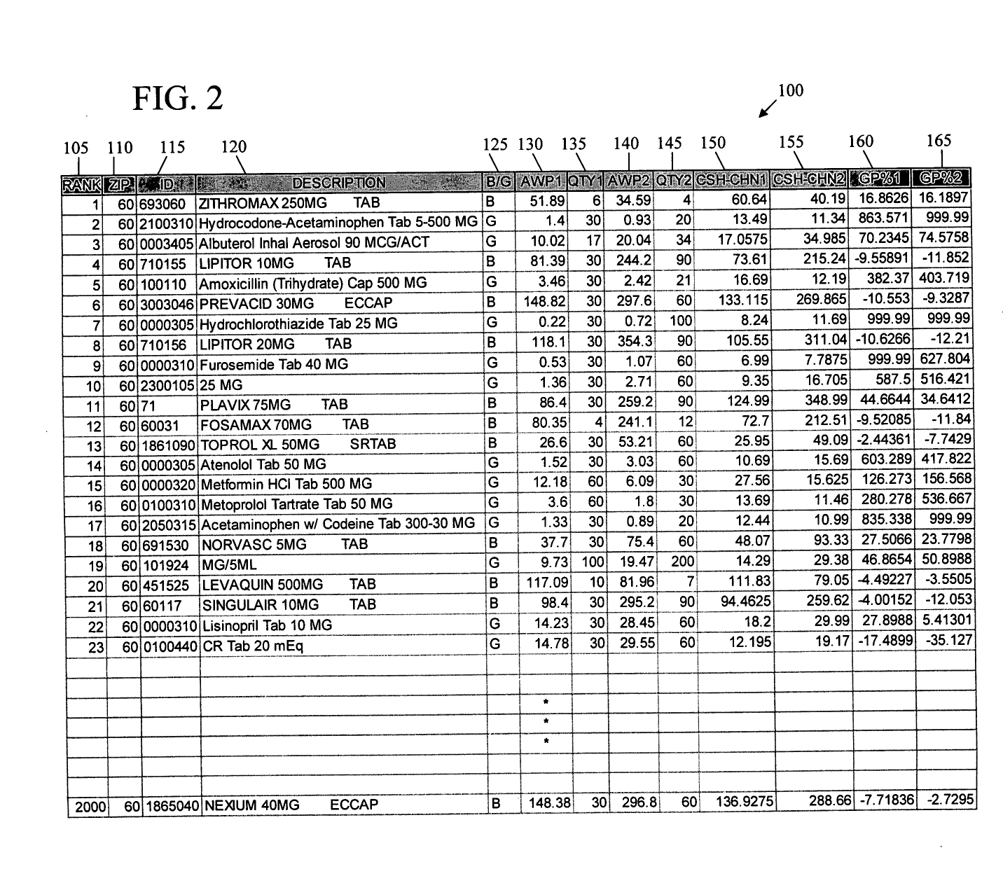

A sample pricing schedule, such as a spreadsheet 100, created by the method of FIG. 1, is shown in FIG. 2. The spreadsheet 100 may include any number of drugs. By way of example only, the spreadsheet 100 includes 2000 drugs, wherein the drugs selected represent the top-selling drugs for a particular region. The specific ranking of each drug is stored in column 105 and, when the spreadsheet 100 is used by a pharmaceutical pricing system, the ranking may also represent a database table in which information regarding the specific drug corresponding to the ranking is stored. The region represented by the spreadsheet is stored in column 110. A region may be created using any criteria; for example, all areas having the same first two digits of their zip code may define one particular region. In addition, although 2000 drugs are shown in the spreadsheet 100, any number of drugs may be used.

The spreadsheet 100 further includes columns 115 and 120 containing the identification numbers and descriptions, respectively, of the drugs selected. Each identification number may, for example, be a generic product identifier (“GPI”), a national drug code (“NDC”), or a number provided by General Nutrition Centers, Inc. (“GNC”). An indication of whether the drug is a brand name or a generic is also provided and is shown in column 125.

Column 130 contains the AWP for the drug quantity listed in column 135 and column 140 contains the AWP for the drug quantity listed in column 145. Although two quantities are shown in spreadsheet 100, any number of prescribing quantities or package sizes may be selected for each drug.

The AWP information, as described above, may be acquired from many sources, including First DataBank, Inc. of San Bruno, Calif. For brand name drugs, the AWP information is selected based on the name, form, strength, and quantity of the drugs. For generic drugs, however, the AWP information is selected based on the name, form, strength, and package size of the drugs. In addition, the AWP information for generic drugs may be selected based on an identification number, such as a GPI or GNC number, which is independent of manufacturer. Thereafter, for each generic drug the AWP for the first quantity (column 135) is divided by the quantity to determine a uniform AWP variable. That variable is then multiplied by the various other quantities or package sizes for that drug to determine the corresponding AWP values and achieve a uniform AWP regardless of the manufacturer of the generic drug.

The AWP values for brand name drugs, therefore, represent average values, at the time of their creation, regardless of package sizes and correspond to a median retail value for the brand. The AWP values for generic drugs represent average values regardless of the manufacturer of the drug. These values may be stored in the spreadsheet 100, as described above, and can be used to overwrite AWP values within a pharmaceutical pricing system.

Column 150 contains the MSP for the quantity of column 135 for each drug, wherein the sale was transacted in a chain pharmacy to a cash customer. Similarly, column 155 contains the MSP for the quantity of column 140 for each drug, wherein the sale was transacted in a chain pharmacy to a cash customer. The MSP represents the median sales price of each quantity of each drug for a particular time period for the region.

Alternatively, the MSP may represent transactions involving different types of pharmacies, such as independent pharmacies and mass merchandisers, and/or different types of customers, such as insurance companies or alternative third parties. As another alternative, the minimum or maximum sales price for the region may be used, rather than the median sales price for the region.

The last two columns, 160 and 165, each contain a GP %. Column 160 represents the GP % of the quantity of column 135 of the drug and is based on the AWP of column 130 and the MSP of column 150. Column 165 represents the GP % of the quantity of column 145 of the drug and is based on the AWP of column 140 and the MSP of column 155.

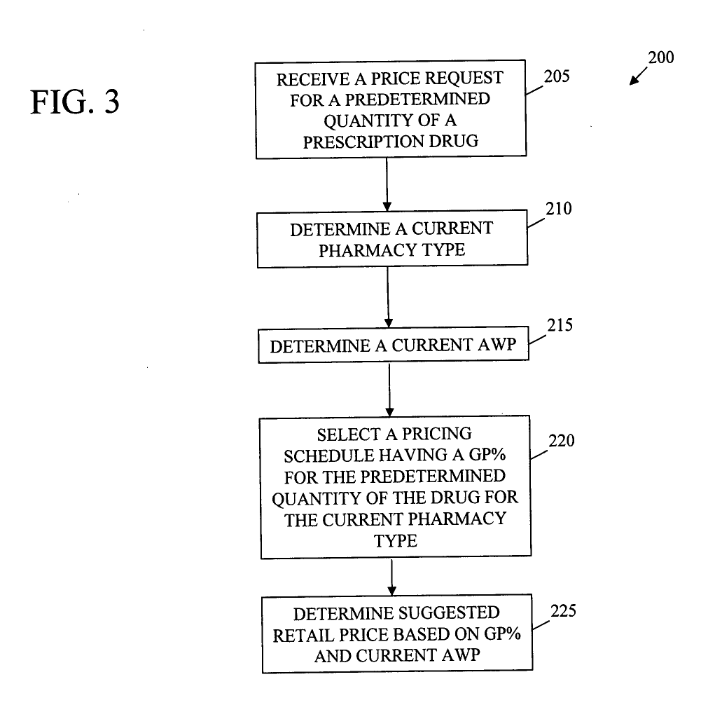

Turning now to FIG. 3, a method of utilizing a pricing schedule, such as spreadsheet 100 of FIG. 2, to establish a suggested price of a prescription drug is shown at 200. At block 205, a price request for a predetermined quantity of a prescription drug is received. As an illustration, a suggested price may be requested for 30 10 MG tablets of Lipitor.

At block 210 a current pharmacy type is determined, wherein the current pharmacy type could be, but is not limited to, an independent pharmacy, a chain pharmacy, or a mass merchandiser. For this illustration, the current pharmacy type from which the price request for Lipitor has originated is a chain pharmacy. Next, at block 215, a current AWP for 30 10 MG tablets of Lipitor is determined for the drug. The current AWP may be acquired form the same source identified above and may, for purposes of this illustration, be $81.55.

At block 220 a pricing schedule containing a GP % for the predetermined quantity of the drug for the current pharmacy type is selected. Using the spreadsheet 100, specifically row 4 of the schedule, and the equation stated above (i.e., ((1−(ASP/AWP))*−1)*100), the GP % for 30 Lipitor tablets is: −9.55891%. And finally, at block 225, a suggested price based on the calculated GP % and the current AWP is determined: −9.55891%*$81.55=$73.75.

Suitable processors for creating and utilizing the pricing schedule of the present invention include any personal computer (PC), or similar processor, running a Windows, Unix or other PC operating system. Where a LAN or WAN network is employed, standard PC networking hardware and software may be included in the PCs. Desirably, the processors will have redundant memory and information storage, such as by one or more of non-volatile memory, a hard disk drive, a floppy disk drive, a CD-write drive and the like.

Applications programs suitable for recording and manipulating the pricing schedule include relational database software such as the Windows-NT-based Microsoft ACCESS database as well as ORACLE, SYBASE and INFORMIX database software, and software languages such as Visual Basic, Java, or other language compliant with American National Standards Institute (ANSI) Standard 256.

In addition, the above methods of creating and utilizing a pricing schedule may be used alone or in conjunction with other systems, such as pharmaceutical pricing systems. For example, the spreadsheet 100 of FIG. 2 may be used with Pharmaserv®, a product offered by McKesson Pharmacy Systems of Livonia, Mich. The pricing schedule is made available to Pharmaserv® by manually or automatically creating tables containing data representing the drugs listed in spreadsheet 100.

### INDUSTRIAL APPLICATION

The method of creating a pricing schedule for use by a pharmaceutical pricing system of the present invention can be used to determine a suggested retail price for a brand name or generic drug. This method is advantageous because it assists pharmacies in establishing competitive and profitable pricing strategies.

The invention has been described in an illustrative manner in order to enable a person of ordinary skill in the art to make and use the invention, and the terminology used is intended to be in the nature of description rather than of limitation. It is understood that the invention may be practiced in ways other than as specifically described, and that all modifications, equivalents, and variations of the present invention, which are possible in light of the above teachings and ascertainable to a person of ordinary skill in the art, are specifically included within the scope of the impending claims.

I claim:

1. A method of creating a pricing schedule for use by a pharmaceutical pricing system, the method comprising the steps of:
determining an Average Wholesale Price (“AWP”) for the at least one predetermined quantity of a prescription drug;
determining a median sales price for the at least one predetermined quantity of the prescription drug, wherein the median sales price is based on historical sales data;
calculating a gross profit percentage, wherein the gross profit percentage is based on the AWP and the median sales price; and
storing the gross profit percentage in the pricing schedule.

2. The method of claim 1, wherein the prescription drug is a brand name drug.

3. The method of claim 2, wherein the AWP is based on the form and strength of the prescription drug.

4. The method of claim 1, wherein the prescription drug is a generic drug.

5. The method of claim 4, wherein the AWP is based on the form, strength, and package size of the prescription drug.

6. The method of claim 1, wherein the median sales price for the prescription drug represents sales to cash customers.

7. The method of claim 6, wherein the median sales price represents sales by a chain pharmacy.

8. The method of claim 6, wherein the median sales price represents sales by a mass merchandiser.

9. The method of claim 6, wherein the median sales price represents sales by an independent pharmacy.

10. A method of utilizing a pricing schedule to establish a suggested retail selling price of a prescription drug, the method comprising the steps of:
determining an Average Wholesale Price (“AWP”) for at least one predetermined quantity of a prescription drug;
determining a current pharmacy type;
selecting a pricing schedule having a gross profit percentage for the at least one predetermined quantity of the prescription drug, wherein the at least one gross profit percentage is calculated for the predetermined pharmacy type; and
determining the suggested price for the at least one predetermined quantity of the prescription drug based on the AWP and the gross profit percentage.

11. The method of claim 10, wherein the prescription drug is a brand name drug.

12. The method of claim 11, wherein the AWP is based on the form and strength of the prescription drug.

13. The method of claim 10, wherein the prescription drug is a generic drug.

14. The method of claim 13, wherein the AWP is based on the form, strength, and package size of the prescription drug.

15. The method of claim 10, wherein the median sales price for the prescription drug represents sales to cash customers.

16. The method of claim 10, wherein the pharmacy type is a chain pharmacy.

17. The method of claim 10, wherein the pharmacy type is a mass merchandiser.

18. The method of claim 10, wherein the pharmacy type is an independent pharmacy.

19. The method of claim 10, wherein the gross profit percentage is based on an AWP and a median sales price.

20. The method of claim 19, wherein the median sales price is based on historical sales data.
